(19) United States
(12) Patent Application Publication
(10) Pub. No.: US 2020/0403259 A1
(43) Pub. Date: Dec. 24, 2020

(54) Carbon dioxide-Carbonate powered engine

(71) Applicant: Rachel Wulf Smith, Williamsburg, VA (US)

(72) Inventor: Rachel Wulf Smith, Williamsburg, VA (US)

(21) Appl. No.: 16/445,499

(22) Filed: Jun. 19, 2019

(51) Int. Cl. H01M 8/0612; B60L 58/30; H01M 8/04089; H01M 8/04746

(52) U.S. Cl. CPC H01M 8/0612; H01M 8/04753; H01M 8/04089; B60L 58/30

(57) ABSTRACT

The following is a design for a carbon dioxide-carbonate powered engine, which utilizes the chemical energy derived from the reaction between stored aqueous calcium carbonate (CaCO₃) and introduced atmospheric carbon dioxide (CO₂) and water within an internal fuel cell in order to power a conventional motor. The electrons from carbonate ions (CO₃²⁻) formed from dissociated CaCO₃ travel through the conductive wire which generates electricity for the attached engine. The electrons are deposited into the cathode chamber of the fuel cell in which they react with the dissolved carbon dioxide (in the form of carbonic acid) which yields a byproduct of bicarbonate (HCO₃⁻). Storage reservoirs are utilized for CaCO₃, water, and HCO₃⁻. The utilization of the reaction between CaCO₃ and CO₂ is advantageous in comparison to traditional fossil fuel sources since this is a sustainable energy source that removes carbon dioxide, a known greenhouse gas, from the atmosphere.

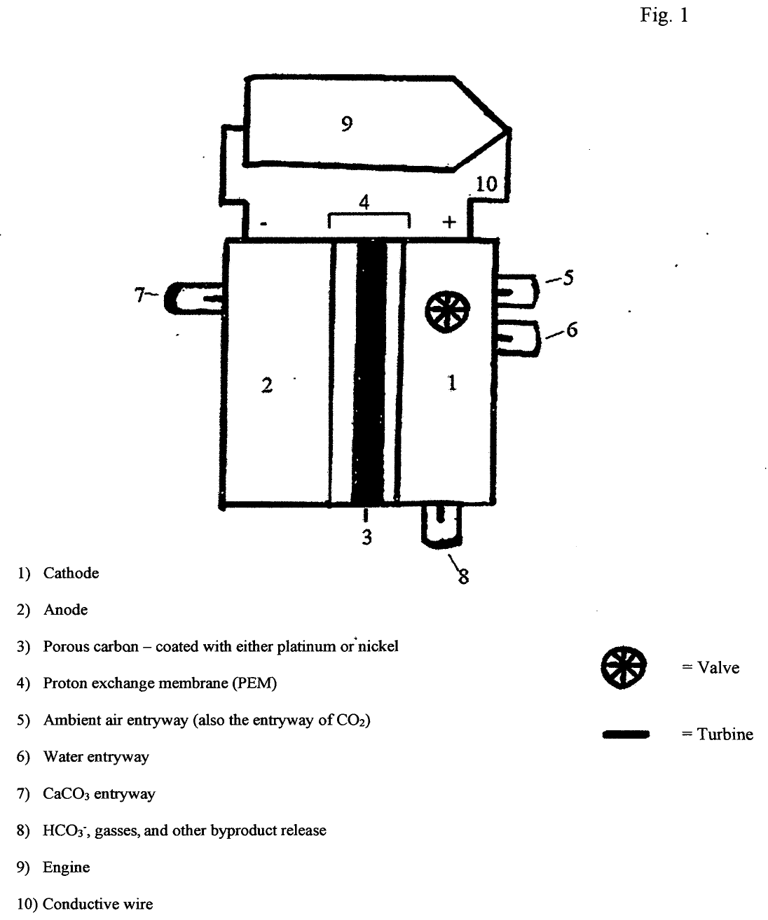

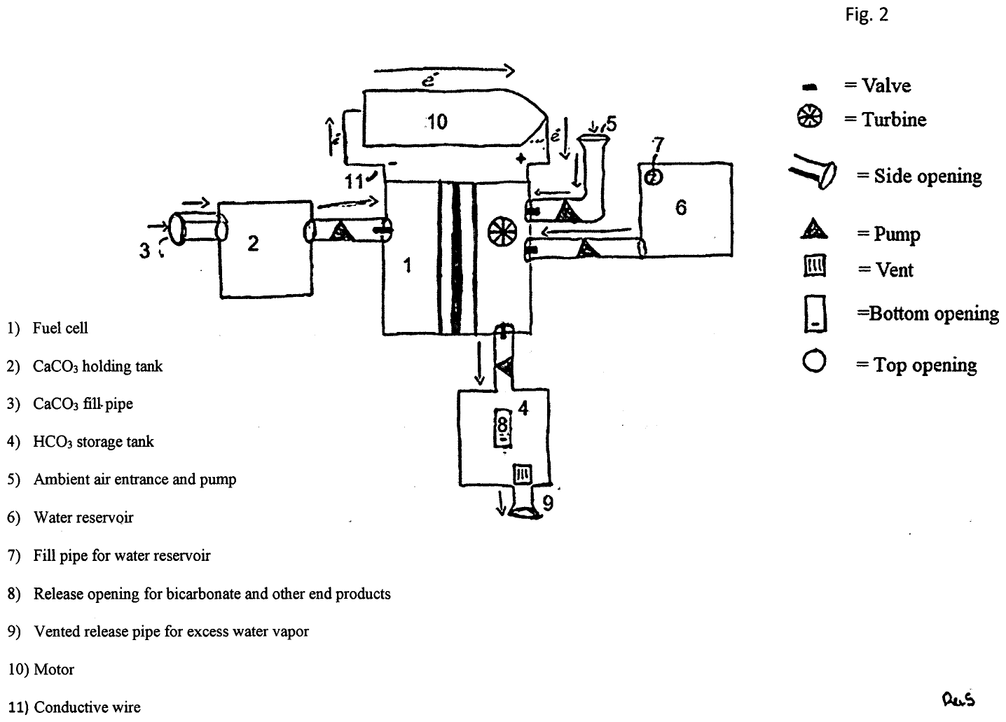

### SUMMARY

The following is a design for a carbon dioxide-carbonate powered engine, which utilizes the chemical energy derived from the reaction between stored aqueous calcium carbonate (CaCO₃) and introduced atmospheric carbon dioxide (CO₂) and water within an internal fuel cell in order to power a conventional motor. The electrons from carbonate ions (CO₃²⁻) formed from dissociated CaCO₃ travel through the conductive wire which generates electricity for the attached engine. The electrons are deposited into the cathode chamber of the fuel cell in which they react with the dissolved carbon dioxide (in the form of carbonic acid) which yields a byproduct of bicarbonate (HCO₃⁻). The utilization of the reaction between CaCO₃ and CO₂ is advantageous in comparison to traditional fossil fuel sources since this is a sustainable energy source. In addition, this fuel source removes carbon dioxide, a known greenhouse gas, from the atmosphere. Therefore, the widespread utilization of carbon dioxide as a fuel source could slow and eventually reverse carbon emission rates.

### BACKGROUND OF INVENTION

Fossil fuels have at present been the dominant fuel source used in vehicles. However, fossil fuels are nonrenewable, meaning that they are being used at a faster rate than can be replenished, and thus we must turn to other energy alternatives. In addition, the combustion of fossil fuels has led to the abnormally abundant release of greenhouse gasses, such as carbon dioxide, into the atmosphere. The addition of carbon dioxide and other greenhouse gasses into the atmosphere at a faster rate than they can be removed has been found to have a significant impact on the atmosphere, and has led to the many adverse environmental effects known as climate change. One method of decreasing the amount of carbon dioxide in the atmosphere has been through carbon sequestration, or the removal of carbon dioxide from the atmosphere to be deposited in another form. The entities that remove the carbon dioxide are known as “carbon sinks”. One common “carbon sink” that is utilized in order to offset carbon emissions is the cultivation of trees and other plants, which take in carbon dioxide during photosynthesis. However, the ocean is also a significant carbon sink. Carbon dioxide dissolves readily in the ocean, where it reacts with calcium carbonate to form bicarbonate. In the ocean, this reaction has led to ocean acidification, which has led to adverse impacts on marine organisms that cannot survive in acidic conditions, and those which depend on calcium carbonate for protective shells. However, this chemical reaction between carbon dioxide and calcium carbonate can be utilized as a clean energy fuel source that also acts as a “carbon sink”.

### DESCRIPTION

The carbon dioxide-carbonate engine includes an internal combustion fuel cell that utilizes the chemical energy derived from stored aqueous calcium carbonate (CaCO₃) and introduced atmospheric carbon dioxide (CO₂). The reaction of CO₂ and CaCO₃ takes place within an internal fuel cell, in which the aqueous CaCO₃ is located in the anode, and the atmospheric CO₂ is located in the cathode. The reaction of CO₂, H₂O and CaCO₃ yields byproducts of bicarbonate (HCO₃⁻). A vehicle battery provides the initial current for the internal combustion reaction to take place. Conventional internal combustion engine (ICE) fuel cell structures, components, and materials are used for this design. The introduced atmospheric carbon dioxide will be sourced from ambient air, and will contain a mixture of gasses. The carbon dioxide will react with the water in the cathode to form carbonic acid (H₂CO₃), which will then react with the dissolved carbonate ions from dissociated aqueous calcium carbonate. Highly concentrated solutions of calcium carbonate are recommended. Electrons from the carbonate ion will pass through a conductive wire from the anode to the cathode which will generate an electrical current. The electrons then react with the carbonic acid to form bicarbonate. Aqueous bicarbonate is released from the cathode into a holding tank, where it can later be disposed of.

The other atmospheric gasses collected with the carbon dioxide will pass through the cathode chamber to be released through the exit opening along with the bicarbonate byproduct. This opening includes an adjustable control valve that will release the gasses, bicarbonate, and other byproducts after the reaction has taken place. It is possible that the electrons from the carbonate ions may react with other dissolved gasses within the fuel cell. Although a different byproduct will form, this will not likely have an effect on the electrical efficiency, since the generation of electricity is powered by the movement of the ions towards the cathode, and not by the formation of bicarbonate.

Atmospheric carbon dioxide enters the vehicle through a curved tube-like opening that is placed facing the anterior region of the vehicle such that maximum airflow into the opening is achieved. The atmospheric carbon dioxide is introduced into the fuel cell where it is dissolved in water present in the fuel cell. The water is released from a separate reservoir into the fuel cell by an adjustable control valve. The salt sodium chloride (NaCl) may be added to the reservoir water if desired in order to prevent freezing in cold conditions. The carbon dioxide is transported to the fuel cell by a carburetor or pump, which also aids in bubbling the carbon dioxide and other gasses through the water. A second rotating device or turbine is to be present in the cathode of the fuel cell in order to further stimulate the dissolving of carbon dioxide in the water. Aqueous calcium carbonate (CaCO₃) is stored in the CaCO₃ holding tank prior to introduction into the anode of the fuel cell. The aqueous CaCO₃ is transported to the anode of the fuel cell by a carburetor or pump.

The aqueous CaCO₃ is transported to the anode of the fuel cell, while the atmospheric carbon dioxide and other atmospheric gasses are transported into the cathode. When dissolved in water, also known as an aqueous solution, CaCO₃ dissociates into calcium ions (Ca²⁺) and carbonate ions (CO₃²⁻). The extra electrons from the CO₃²⁻ ion gain an attraction to the carbonic acid (H₂CO₃) that forms in the cathode after the atmospheric CO₂ is dissolved in water. The electrons from the CO₃²⁻ ion travel from the anode to the cathode, which generates an electrical current to power the motor of the vehicle. The electrons from the CO₃²⁻ ion are then deposited in the cathode in which they react with the carbonic acid. This causes bicarbonate (HCO₃) to form. Other sources of carbonate ions may be used for this reaction, if desired. However, calcium carbonate is recommended due to its low cost and relative abundance. The optimal metered input of CO₂ and CaCO₃ will be a 1:1 ratio of CO₂:CaCO₃. However, other ratios are also acceptable for generating power.

The aqueous bicarbonate is then transported from the cathode to a holding tank by a carburetor or pump. A vent is located within the holding tank in order to release excess water vapor to the outside of the vehicle. The bicarbonate and remaining water may be emptied from the tank through an opening in the bottom of the tank. A secondary heating device may be attached to the outside of the bicarbonate tank, if desired, in order to vaporize the water within the bicarbonate solution. This would decrease the frequency of emptying the bicarbonate holding tank by concentrating the bicarbonate-water solution. The liquid in this tank should be able to withstand freezing in cold temperatures due to the concentration of dissolved ions within the solution.

There are three tanks utilized in the design. The first tank contains aqueous calcium carbonate and may subsequently be referred to as the “CaCO₃ tank”. One opening in the CaCO₃ tank connects to the anode of the fuel cell, in which the CaCO₃ enters from the tank. The second opening to the CaCO₃ tank connects to the outside of the vehicle, in which the tank can be refilled from an outside source of aqueous CaCO₃.

The second tank contains aqueous bicarbonate. The first opening connects to the cathode of the fuel cell in which sodium carbonate exits the fuel cell. The second opening allows the sodium carbonate to be removed from the tank and surrounding vehicle. The sodium carbonate reservoir also contains a vented opening that allows excess water vapor to be released outside of the vehicle into the surrounding atmosphere.

The third tank contains liquid water which may contain dissolved sodium chloride (NaCl), if desired. The first opening connects to the cathode of the fuel cell in which the water may enter. The second opening connects to the outer part of the vehicle in which the tank can be refilled from an outside source.

1. The engine is comprised of a fuel cell in which the reaction of carbon dioxide (CO₂) and calcium carbonate (CaCO₃) takes place. The first means, or reaction input, includes the introduction of gaseous carbon dioxide mixed with ambient air to aqueous calcium carbonate in metered amounts. The second means, or output is the production of sodium carbonate and water.

2. In which the following terms are defined as follows: “CO₂” refers to carbon dioxide, and “CaCO₃” refers to calcium carbonate. “The CO₂—CaCO₃ reaction” refers to the reaction between carbon dioxide and sodium hydroxide. The chemical symbol “HCO₃⁻” refers to bicarbonate, “CO₃²⁻” refers to carbonate, and the chemical symbol “H₂CO₃” refers to carbonic acid. The term “fuel cell” refers to any container or device in which an internal reaction occurs, such as the reaction between CaCO₃ and CO₂. The term “aqueous” refers to the process of the following subject being dissolved in water. The terms “pump” and “carburetor” refer to any device that will aid in the circulation or transport of any substance, such as, but not limited to transport into and out of the fuel cell. The terms “end products” and “byproducts” refer to any substance produced from a chemical reaction within the fuel cell. The term “vehicle” refers to the vessel that which the fuel cell provides energy to. A vehicle by this definition may be mobile, such as a car, or it may be sedentary, such as a portable electric generator. This design may be incorporated into any motorized vehicle, as defined above. The terms “holding tank”, “tank” or “reservoir”, include any apparatus that which contains aqueous solutions, liquids, solids, or gasses such as, but not limited to, liquid water, aqueous calcium carbonate and aqueous bicarbonate.

3. In which other sources of carbonate ions (CO₃²⁻) may be used in the fuel cell reaction. Calcium carbonate is recommended due to its relative abundance and low cost. Likewise, other sources of carbon dioxide other than from ambient air may be used for the fuel cell reaction.
